(19) United States
(12) Patent Application Publication
(10) Pub. No.: US 2018/0352451 A1
(43) Pub. Date: Dec. 6, 2018

(54) METHOD AND SYSTEM FOR TESTING TELECOMMUNICATIONS INFRASTRUCTURE

(71) Applicant: MILL DEVELOPMENT INTERNATIONAL PTY LTD, VICTORIA (AU)

(72) Inventors: NICK BONNETT, VICTORIA (AU); MARK VANSTON, VICTORIA (AU); BRETT VAN ZUYLEN, NEW SOUTH WALES (AU); PAUL MILFORD, QUEENSLAND (AU)

(21) Appl. No.: 15/555,270

(22) PCT Filed: Aug. 28, 2015
(86) PCT No.: PCT/AU2015/000520

§ 371 Date: Sep. 1, 2017

(30) Foreign Application Priority Data
Mar. 2, 2015 (AU) 2015900722

(51) Int. Cl. H04W 24/06; H04W 24/10; H04L 12/26; H04W 48/16; H04W 36/00

(52) U.S. Cl. CPC H04W 24/06; H04W 24/10; H04W 36/0085; H04L 43/0852; H04W 48/16; H04L 43/0888

(57) ABSTRACT

A method and system for testing the performance of one or more cells in a wireless communication network using a mobile device is provided. The system and method includes determining cell information relating to the cell to be tested; determining one or more pre-test criteria and one or more post-test criteria based on the cell information; then determining whether the one or more pre-test criteria are satisfied. If one or more of the pre-test criteria are satisfied, performance of the cell is tested via the mobile device by measuring data related to the one or more pre-test criteria, and determining whether the one or more post-test criteria are satisfied.

### TECHNICAL FIELD

The present application relates to systems and methods for testing telecommunications infrastructure and in particular wireless communication systems.

### BACKGROUND OF INVENTION

Commissioning is one the final steps in the deployment of or reconfiguration of infrastructure at a site having a wireless communication system. A site can only be considered operationally ready when results of testing of the site are determined. Conventional techniques for commissioning new wireless installations typically rely on a combination of paper based checklists and bespoke performance monitoring tools for verifying configurations and testing service performance.

The process of commissioning involves checking that the installation at a site matches the design of the site, namely ensuring the correct equipment is installed and that databases have been updated and that the site is operationally ready.

In addition, a series of performance tests are performed on the site. These tests may verify that the services offered by the deployed technology are functioning. For example, commissioning of a 3G deployment (supporting voice and data) will involve making voice calls, checking the emergency services can be reached and that data performance meets minimum criteria. 4G or Wi-Fi deployments may additionally focus on data performance. Tests may also be made to ensure service continuity (handover) between cells/technologies at the site and also between different sites.

A problem with existing performance tools used for testing is that they are either limited in functionality and accuracy (but albeit inexpensive) or have high accuracy and/or are complex (and therefore expensive).

Another problem is that the process of commissioning can also vary from site to site based on the technology deployed and the configuration. The activities required and minimum performance thresholds vary based on these factors. This complicates existing processes as technicians follow a generic paper process catering for all deployment types, having to decide which parts of the process apply to the current installation. They also need to refer to lists of minimum performance criteria and apply these to performance tests to determine of the tests are successful.

On completion of commissioning, the performance results are documented along with the manual inspection checks. This document is then emailed (which can be a scanned copy of the document) for inclusion in the acceptance process. Since the field technicians are typically remote from the office, these reports can take several weeks to become available.

Another problem with the current paper based approach is that results are open to interpretation, user error and falsification of results. There is no accurate record of the location the tests were performed and no reliable way to know who performed tests should an audit be conducted.

It would therefore be desirable to provide a method and system for testing telecommunications infrastructure that ameliorates or at least alleviates one or more of the above problems or provides a useful alternative.

Reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which the specification relates.

### SUMMARY OF INVENTION

According to a first aspect, the present invention provides a method for testing the performance of one or more cells in a wireless communication network using a mobile device, the method including: determining cell information relating to the cell to be tested; determining one or more pre-test criteria and one or more post-test criteria based on the cell information; determining whether the one or more pre-test criteria are satisfied; such that if one or more of the pre-test criteria are satisfied, testing the performance of the cell via the mobile device by measuring data related to the one or more pre-test criteria, and determining whether the one or more post-test criteria are satisfied.

Advantageously, the present invention ensures tests are performed in the optimal location and radio environment. Commissioning of equipment often requires the peak performance or a minimum level of performance of a new deployment to be measured. To measure either peak or a minimum level of performance, the user who is testing the equipment is required to be in a specific location and radio environment. If the user is in a suboptimal location & environment the performance test is likely to fail and the user will need to find a more suitable location for the test. This location may be defined by the distance from the site and how far away, in degrees the tester is from the face of the antenna (angle to bore site) amongst other factors. The radio environment is defined by the signal level and signal quality (level of interference).

Advantageously, present invention uses the location of the mobile device (via GPS for example) together with knowledge of the site configuration to determine the location and bearing to the antenna. The radio environment is captured from the mobile device or network and in combination with pre-test and post-test criteria used to warn the user if the location, bearing and radio environment thresholds are not met.

The radio environment may include signal level, (RSSI, RSRP, RSCP, received signal power), signal quality (ec/lo, RSRQ, SNR, RxQual), and neighbouring cell signal levels. In a further advantage, the user is shown in real time each of the parameters, allowing them to move to suitable location before conducting a test. In a further advantage, time is saved as the test is only performed in a location deemed likely to yield a pass result for the performance test.

Preferably, the pre-test criteria and post-test criteria are automatically determined based on the cell information. The cell information includes one or more of the type of cell technology (e.g., 2G, 3G, 4G, 5G, WiFi), the band of operation (e.g. 700, 2400, 2600 MHz), the bandwidth utilised (5,10, 15, 40 MHz), cell identifiers (cell global indicator [CGI], operator specific identifiers, WiFi SSID or WiFi SSID, MAC/BSSID), cell GPS location, antenna type, antenna bearing, antenna height, cell channel, site backhaul connection bandwidth or type, current cell voice or data usage, number of current connected users, configured peak site throughput. It will be appreciated that any number of pre-test or post-test criteria exist and that this list is not exhaustive. The types of tests that may be carried out include: download tests, upload tests, latency tests, call origination and termination tests, emergency services call tests, VoIP tests, interference measurement. It will be appreciated that any number of tests may be carried out and this list is not exhaustive.

The pre-test criteria includes one or more of a signal level threshold, a signal quality threshold, a distance threshold and a bearing threshold, cell technology type, band of operation, bandwidth utilised, cell identifiers, cell GPS location, antenna type, antenna bearing and antenna height. The pre-test criteria may also include a calculated or predefined zone represented on a map.

The pre-test criteria preferably include mandatory pre-test criteria and optional pre-test criteria. Mandatory pre-test criteria requires that the criteria be passed in order to complete the test, while optional pre-test criteria may allow the test to proceed but with a warning.

The post-test criteria preferably include mandatory post-test criteria and optional post-test criteria. Mandatory post-test criteria requires that the criteria be passed in order to pass the test, while optional post-test criteria may allow the test to be passed but with a warning.

Preferably, the step of determining whether the one or more pre-test criteria are satisfied, includes: determining the distance from the mobile device to the cell and comparing against the distance threshold; determining the bearing of the mobile device to the cell and comparing against the bearing threshold; determining the signal level between the mobile device and the cell and comparing against the signal level threshold; and determining the signal quality between the mobile device and the cell and comparing against the signal quality threshold.

Preferably, the method further includes the step of displaying on the mobile device, one or more of: the determined distance from the mobile device to the cell; the determined bearing of the mobile device to the cell; the determined signal level between the mobile device and the cell; the determined signal quality between the mobile device and the cell. A recommendation is then made for a test location based on one or more of the determined distance, bearing, signal level or signal quality between the mobile device and the cell.

Pre-test criteria may be dependent on the location and radio environment (signal level and quality) of the phone. Advantageously, these metrics are extracted from the mobile device or network in real time, used for pre-test criteria and also displayed to the user. It will be appreciated that criteria can be dependent on the radio environment (as measured by the phone) and/or cell configuration information (measured by the phone or via a database). It will also be appreciated that additional information may be retrieved from other data sources using cell identity, for example an antenna location and bearing to calculate distance and bearing to site.

Advantageously, the present invention ensures that the correct cell is tested and that the radio configuration of the cell is known by the user and that appropriate success criteria can be applied based on the technology and configuration being tested.

Advantageously, the present invention provides a dedicated and detailed radio environment and/or cell configuration that can be viewed on the mobile device enabling on the spot diagnostics by the user.

Preferably the post-test criteria include one or more of a minimum performance threshold, a required number of tests threshold, user input (such as selection from a list), network statistics (e.g. network performance counter), measured voice quality, changed radio environment during test (e.g. change of cell), user location and the like. It will be appreciated that post-test criteria can be dependent on the radio environment (as measured by the phone) and/or cell configuration information (measured by the phone or via a database). It will also be appreciated that additional information may be retrieved from other data sources using cell identity such as cell related information like cell backhaul configuration to measure maximum achievable throughput of a cell backhaul link (measured via a database) or cell network performance information (measured via a database) like current cell traffic throughput to allow for traffic generated by existing users to be taken into account when assessing post-test criteria. Additionally for example, an antenna location and bearing to calculate distance and bearing to site could be used to impact post-test criteria.

Determining whether the one or more post-test criteria are satisfied includes the steps of: determining one or more of the distance, bearing, signal level and signal quality between the mobile device and the cell and comparing against the performance threshold. Determining the one or more post-test criteria are satisfied may further include the step of determining whether the number of tests carried out exceeds the required number of tests threshold.

A handover event may also be tested using the system and method of the present invention. In a handover, continuity of data performance is important as mobile devices move between cells and sites in a network.

In the case of the handover test, the pre-test criteria may include the currently connected radio technology (e.g. 3G or 4G), distance to site, signal level and signal quality.

Advantageously, these metrics are extracted from the mobile device or network in real time, used for pre-test criteria, or post-test criteria and also displayed to the user. It will be appreciated that the criteria may be dependent on the radio environment (as measured by the mobile device or database or network device) and/or cell configuration information (measured by the mobile device or via a database) and/or other network configuration, network performance statistics or general information (as measured by a database or network information service.

Preferably, one or more of: the cells being tested, the current connected cell and location of the mobile device, distance to the current cell, locations of successful and unsuccessful handovers, cell change events and the start and stop of the test are displayed on the mobile device.

Preferably, the present invention also automates the testing of data performance by automatically initiating tests should a previous test meet all pre-test and post-test criteria which results in a time saving. Automation of successive tests is suspended if any of the pre-test criteria are not met or the post-test criteria for the previous test was not met.

Preferably, the post-test criteria for handover includes: one or more throughput thresholds, sample thresholds for failed handover events, the number of samples to measure around a handover event and the number of successful handover events to be measured and a list of handover events to be measured.

Preferably, to determining whether the one or more post-test criteria are satisfied in a handover test includes the steps of: determining the current connected cell and current mobile device location; determining whether the cell has changed and if the cell has changed, comparing the throughput of the cell against the post-test criteria.

Preferably, a reduced rate download is initiated to continuously monitor network performance during handover events.

Handover testing typically involves an extended survey of the site being commissioned and interactions with neighbouring sites. Since these sites can be several kilometres away and the duration of the test can be minutes to hours long, performing a continuous download for an hour or more consumes unnecessary network resources. The present invention advantageously performs a throttled (reduced speed) download to conserve network resources while performing a handover continuity test and detects when there has been a change in the cell and analyses the throughput around the cell change (handover) event via the pre-test and post-test criteria. Advantageously, the handover can then be flagged as a success or failure based on the observed throughput and duration of any throughput degradation around the handover event. Once a list of mandatory and or optional handover events has been performed successfully the test may be considered complete.

Enrichment of results with meta data from radio environment, user location, network configuration may further be provided.

Eyes-free operation is preferably provided by providing haptic or acoustic feedback to the user for when significant events occur during use for example when pre-test or post-test criteria are met or fail.

According to a second aspect, the present invention provides a method for testing the performance of one or more cells in a wireless communication network using a mobile device, the method including: determining cell information relating to the cell to be tested; determining one or more pre-test criteria based on the cell information; determining whether the one or more pre-test criteria are satisfied; such that if one or more of the pre-test criteria are satisfied, testing the performance of the cell via the mobile device by measuring data related to the one or more pre-test criteria.

According to a third aspect, the present invention provides a method for testing the performance of one or more cells in a wireless communication network using a mobile device, the method including: determining cell information relating to the cell to be tested; determining one or more post-test criteria based on the cell information; testing the performance of the cell via the mobile device by measuring data related to the one or more post-test criteria, and determining whether the one or more post-test criteria are satisfied.

According to second aspect, the present invention provides a system for testing the performance of one or more cells in a wireless communication network using a mobile device, the system including: a server configured to determining cell information relating to the cell to be tested; the server determining one or more pre-test criteria and one or more post-test criteria based on the cell information; a mobile device, in communication with the server which determines whether the one or more pre-test criteria are satisfied; such that if one or more of the pre-test criteria are satisfied, performance of the cell is tested via the mobile device by measuring data related to the one or more pre-test criteria, and determining whether the one or more post-test criteria are satisfied.

### BRIEF DESCRIPTION OF DRAWINGS

FIG. 1 of the schematic diagram illustrating the method and system for testing the performance of a cell using a mobile device;

FIG. 2 is a system diagram illustrating the operation of the invention according to an embodiment;

FIG. 3 is a flow diagram illustrating the method of the invention according to an embodiment;

FIG. 4 is a flow diagram illustrating creating a workflow associated with the test together with generation and application of pre-test criteria according to an embodiment;

FIG. 5 is a flow diagram illustrating performance testing of a cell;

FIG. 6A is a screenshot illustrating environmental details captured;

FIG. 6B is a screenshot showing site determination;

FIG. 6C is a screenshot illustrating workflow configuration;

FIG. 6D is a screenshot illustrating site workflow information;

FIG. 6E is a screenshot showing cell test information;

FIG. 6F is a screenshot illustrating warning screens associated with the testing of the cell;

FIG. 6G illustrates the screenshot showing download testing of the cell;

FIG. 6H illustrates a screenshot for a circuit switched fall back originating call test;

FIG. 7 is a flow diagram illustrating creation of a dynamic workflow for performance testing and in particular for a handover test associated with a cell according to an embodiment;

FIG. 8 is a flow diagram illustrating the handover testing detail;

FIG. 9 illustrates screenshots of the handover test in operation.

### DETAILED DESCRIPTION

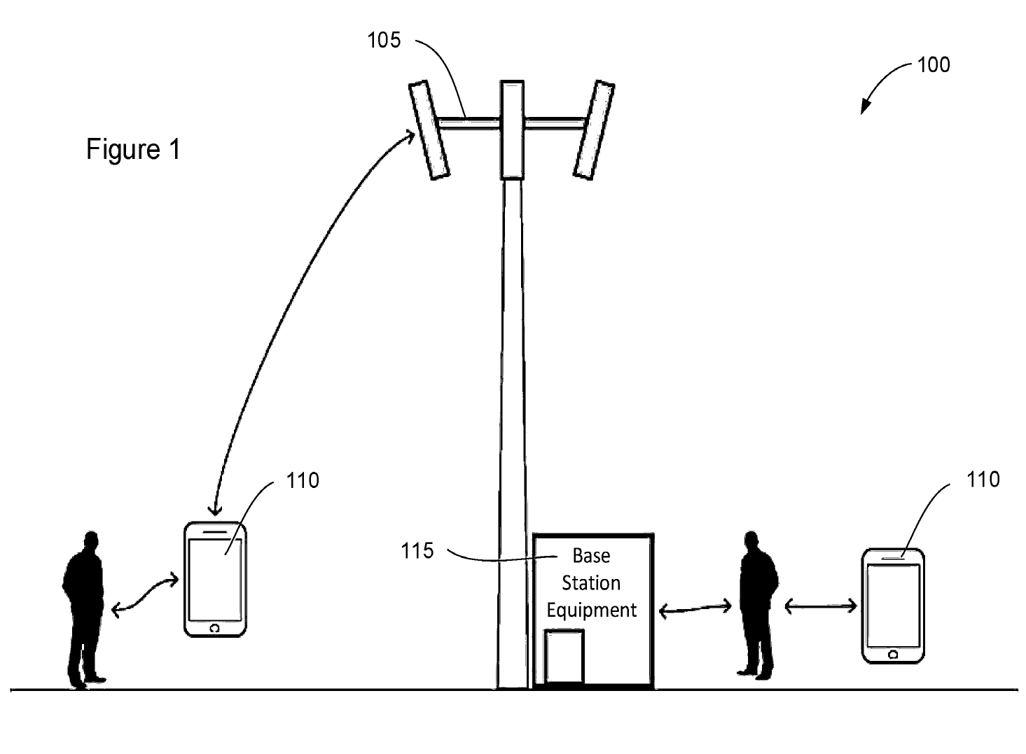

FIG. 1 is schematic diagram which illustrates the system 100 of the present invention method for testing the performance of one or more cells 105 in a wireless communication network using a mobile device 110. It will be appreciated that other equipment such as equipment 115 (WiFi access point inside a building or outdoor public space, cellular remote radio unit, radio unit with integrated antenna (micro/picocell), distributed antenna system, femto cell in customer's house), may also be tested for performance from a mobile device 110. It will be appreciated that cells 105 and equipment 115 may be combined (as in WiFi access points, micro, pico, femto cells) or separate. The mobile device may include a mobile device such as a smart phone or a laptop or the like.

In operation, application software running on the mobile device 110 determines cell information relating to the cell 105 to be tested. One or more pre-test criteria and one or more post-test criteria are determined based on the cell information. This might include the type of cell, the type of test to be carried out on the cell etc. It is then determined, via the mobile device, whether the one or more pre-test criteria are satisfied. Provided the pre-test criteria are satisfied, testing of the performance of the cell via the mobile device is allowed by measuring data related to the one or more pre-test criteria, and determining whether the one or more post-test criteria are satisfied. Post-test criteria may be determined automatically from the cell information.

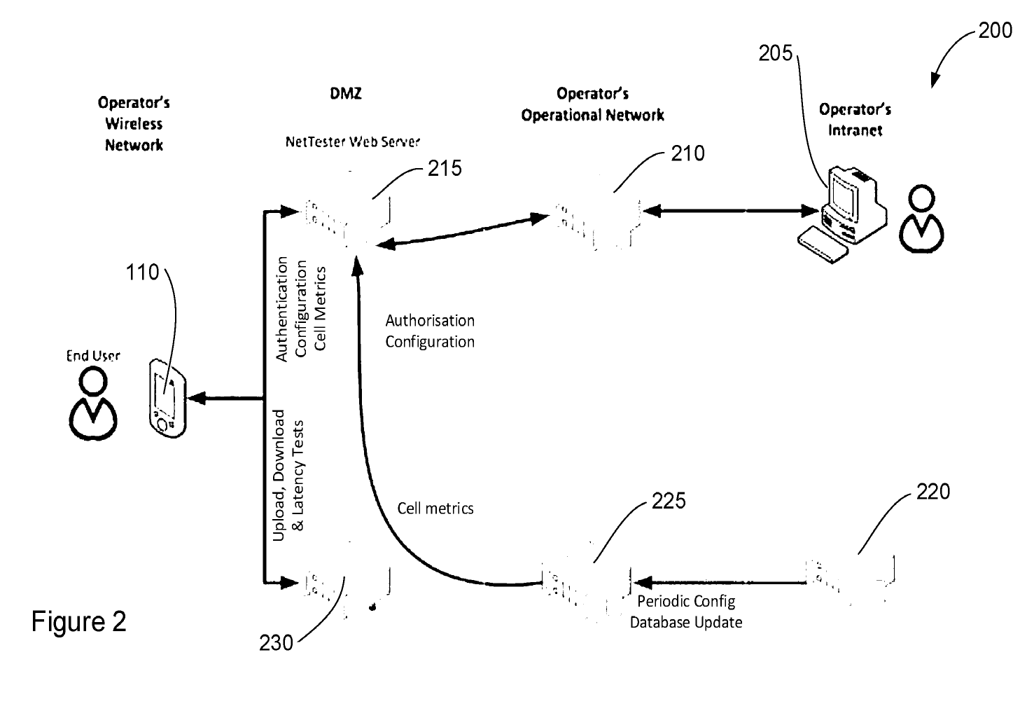

During the test, the user of the application on the mobile device 110 has environment feedback provided to them (such as signal level, signal quality and distance from the cell) and the application software which resides on device 110 tests cell-performance and records results which are then electronically transferred to a server at another location (not shown) which will be further described with reference to FIG. 2. Likewise, equipment 115 may be tested by the application residing on mobile device 110.

It will be appreciated that information relating to the radio environment (signal level and quality and the like) may be retrieved via mobile phone, USB modem, cable/DSL modem, Wi-Fi module or from information relayed from network or input by user (using additional measurement equipment). The network to which the mobile device is connected could be cellular, Wi-Fi or fixed (broadband).

The system and method of the present invention will be described in the context of a commercial cell tower/base station but can equally apply to an in building cell, residential Wi-Fi, shopping centre Wi-Fi, enterprise Wi-Fi (office, shops), public Wi-Fi (outdoor, indoor) and the like. It will be appreciated that the system and method of the present invention can equally apply to the processes of auditing, inspections, fault investigation, performance testing, surveys, service level agreement compliance, and the like.

FIG. 2 is a system diagram illustrating the operation of the components of a system for testing the performance of a cell using a mobile device 110. The system 200 includes a maintenance user interface 205 and a configuration database 220 which may reside on the operator's intranet. Also included is a mobile database 210 and configuration cache 225 which may be located in the operator's operational network. The present invention synchronises all results with the databases and tests can be suspended and resumed by the same user or another user. The status and results for the tests are preferably stored on the database server. A summary of all tests, their status and overall result can be queried from the database server.

A web server 215 and a test server 230 may reside in a DMZ or neutral zone or public Internet to interface with the mobile device 110 on the operator's network. Maintenance user interface 205 is connected to the mobile database 210, which in turn is connected to the web server 215. Web server 215 is connected mobile device 110. Network configuration database 220 is connected to configuration cache 225 which in turn is connected to web server 215. Test server 230 is also connected to mobile device 110 via wireless network. The test service 230 includes upload, download and latency tests received by the mobile device 110. Web server 215 receives and provides authentication configuration and cell metrics.

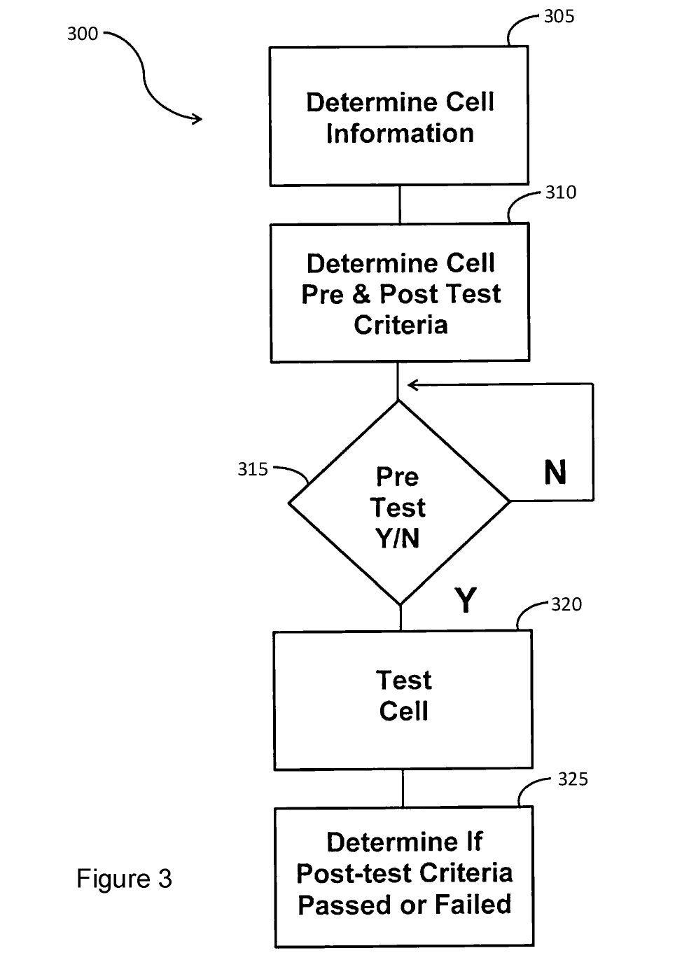

FIG. 3 is a flow diagram illustrating a method 300 for testing the performance of one or more cells in a wireless communication network using a mobile device. At step 305 cell information is determined relating to the cell that needs to be tested. Cell information may include the type of cell, the equipment to be tested, the location of the cell and the like, the technology (e.g., 2G, 3G, 4G, 5G, WiFi), the band of operation (e.g. 700, 2600 MHz), the bandwidth utilised (5,10, 15, 40 MHz), cell identifiers (cell global indicator [CGI], operator specific identifiers, WiFi SSID or WiFi SSID, MAC/BSSID, cell GPS location, antenna type, antenna bearing, antenna height) and the type of test that is to be carried out on the cell.

Control then moves to step 310 in which the pre-test and post-test criteria are determined based upon the cell information at step 305. Pre-test and post-test criteria may be created dynamically or may be predetermined or may be based entirely upon the cell information. Generally the pre-test and post-test criteria may be a static threshold (for example a number which is determined to be a particular threshold for a particular value or may be variable and calculated based on a network/site/phone or other configuration and or environmental factors such as distant to the cell, signal level, time of day etc.).

The pre-test and post-test criteria may be mandatory in that the criteria must be met before a test can be initiated or a test is deemed successful or they may be optional in which criteria are not enforced but will result in a warning being provided.

Control moves then to step 315 for the particular test that is being carried out (as determined at step 305 and it is determined whether or not the one or more test criteria are satisfied. In the event they are not satisfied, control stays at step 315 until the criteria are satisfied. However in the case of pre-test criteria which is not mandatory and is optional, control may move to step 320. Or in the event the pre-test criteria are satisfied, control moves to step 320 in which the testing of the performance of the cell is carried out by measuring data related to the one or more pre-test criteria.

In the case of cell testing and handover testing, this may include signal level thresholds, signal quality thresholds, distance thresholds, bearing thresholds (in relation to the mobile device and the cell), number of cells to be tested, throughput threshold, sample threshold for failed handover and the number of samples to measure a handover event. It will be appreciated that the pre-test and post-test criteria will vary depending on the test to be carried out.

Once the testing has been carried out at step 320, control moves to step 325 in which the results of the test of step 320 are compared against post-test criteria to determine whether or not the test has passed or failed. The post-test criteria, like the pre-test criteria, may be mandatory or optional and depending on the particular situation, and may result in the test being failed, passed or conditionally passed (if warnings exist) and this may be recorded and provided to the user of the mobile device and to any networks connected to the mobile device for reporting and storage.

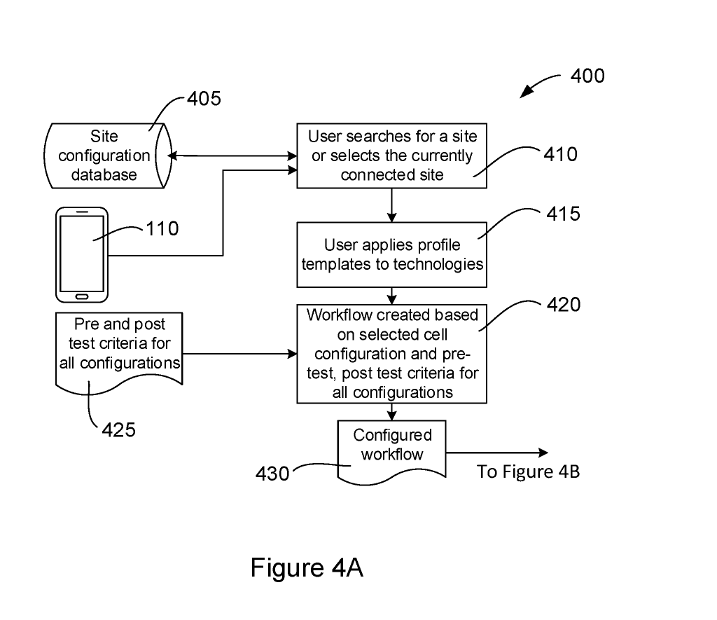

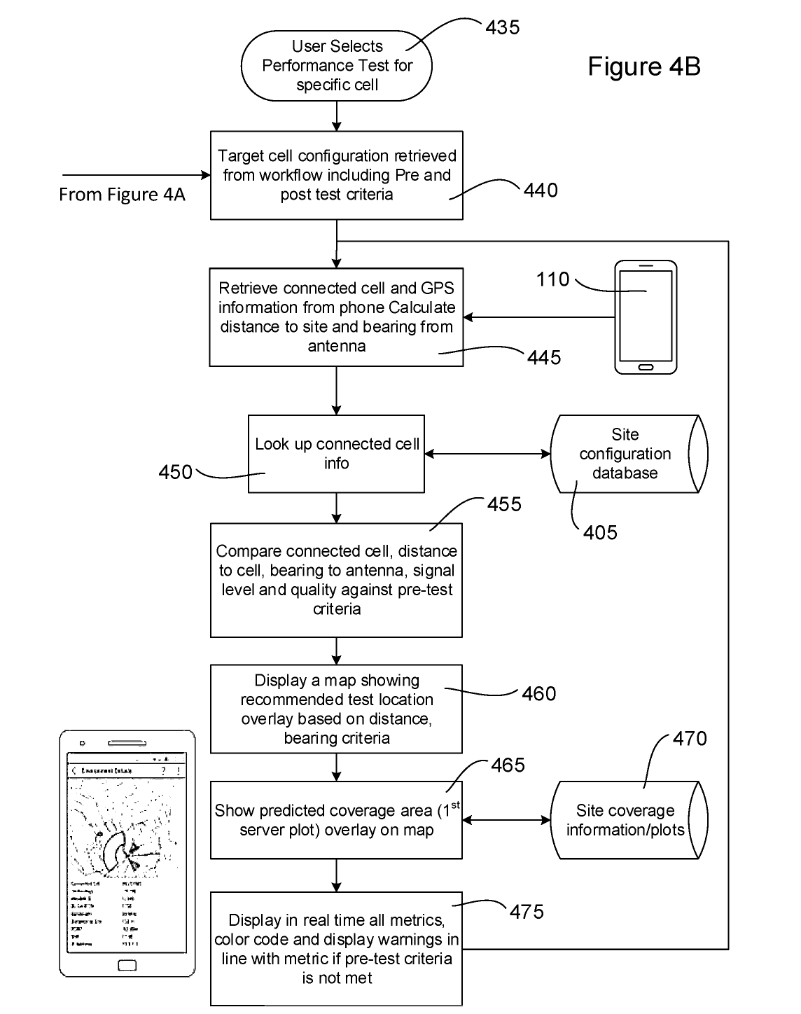

FIG. 4 is a schematic diagram illustrating a method 400 in which creating a workflow for performance testing of a cell 105 via a mobile device 110 is dynamically provided together with generation and application of pre-test criteria. In operation, at 410 the user associated with mobile device 110 searches for a cell site or selects a site which is currently connected. This information may be retrieved from site configuration database 405.

The currently connected site may be determined via mobile device 110 and in particular, retrieving Cell Global Identifier (CGI), WiFi BSSID or other cell identifiers (such as GPS location) from the mobile device

Control then moves to step 415 in which the user may apply profile templates to technologies for example profiles for performing equipment installation, equipment commissioning, site auditing, basic or advanced performance tests, and control moves to step 420 in which a workflow is created based on selected cell configuration and pre-test and post-test criteria. The pre-test and post-test criteria may be obtained from database 425 which contains the pre and post-test criteria for all possible configurations of cells or equipment to be tested (together with the type of test to be carried out). At step 430 a configured workflow is provided which is relevant to that particular cell to be tested and the type of test to be carried out. At step 435 the user selects a performance test for a specific cell they wish to test and control moves to step 440 where cell configuration is retrieved from the workflow 430 including pre-test and post-test criteria to be applied to the test.

Pre-test criteria may include target cell identification, signal level threshold, signal quality threshold, a distance threshold or a bearing threshold and the like. Target cell configuration may include the cell name, the technology type in the location (latitude and longitude for example). Post-test criteria may include a performance threshold and/or a required number of tests. User input (such as selection from a list), network statistics (e.g. network performance counter), measured voice quality, changed radio environment during test (e.g. change of cell), user location and the like.

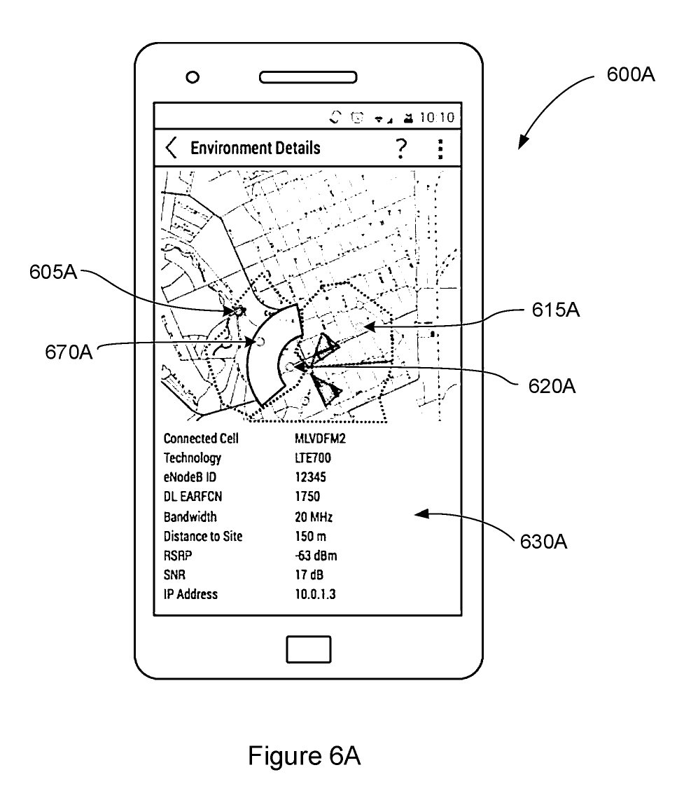

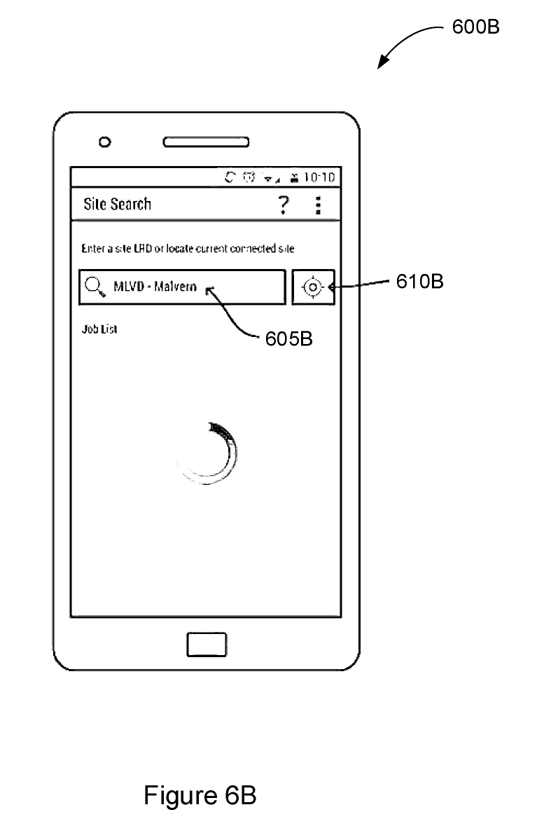

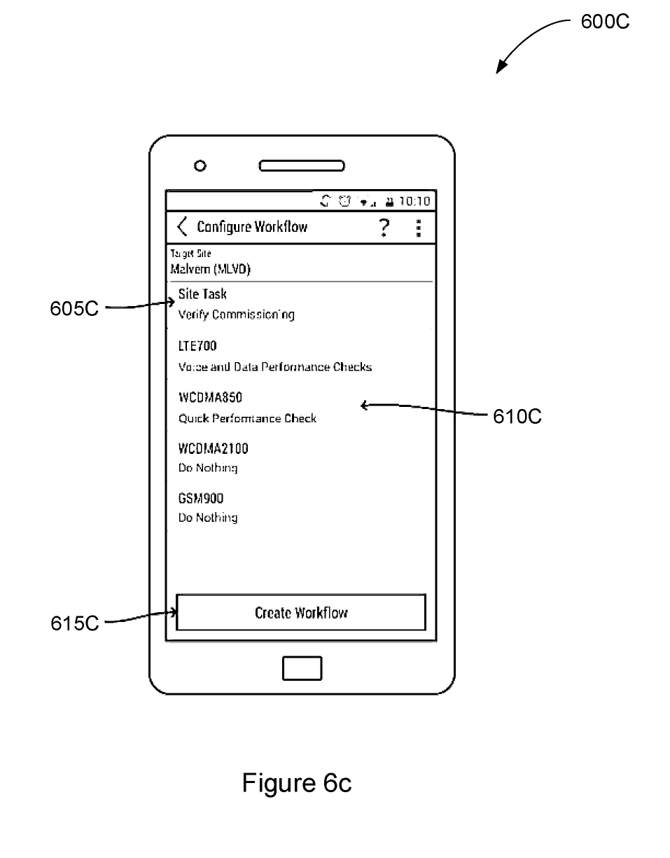

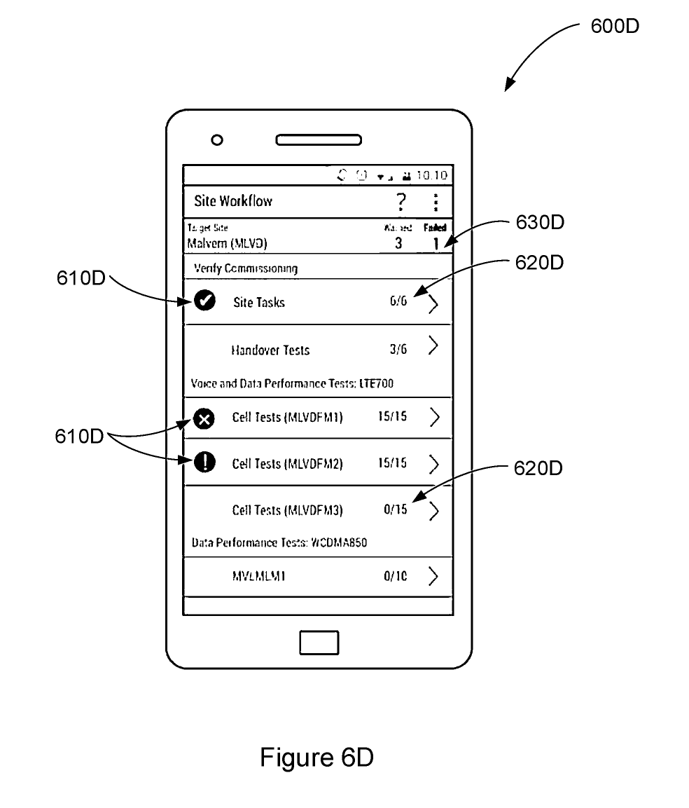

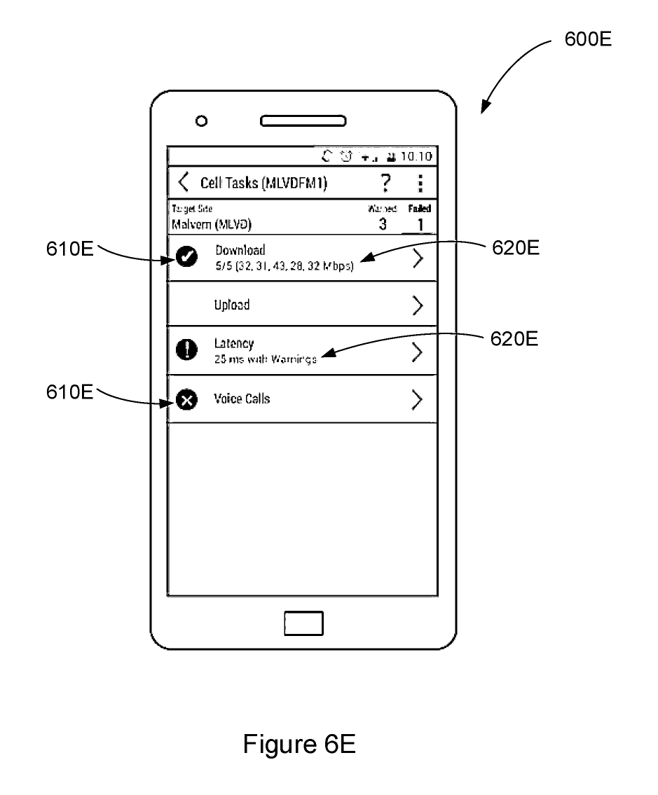

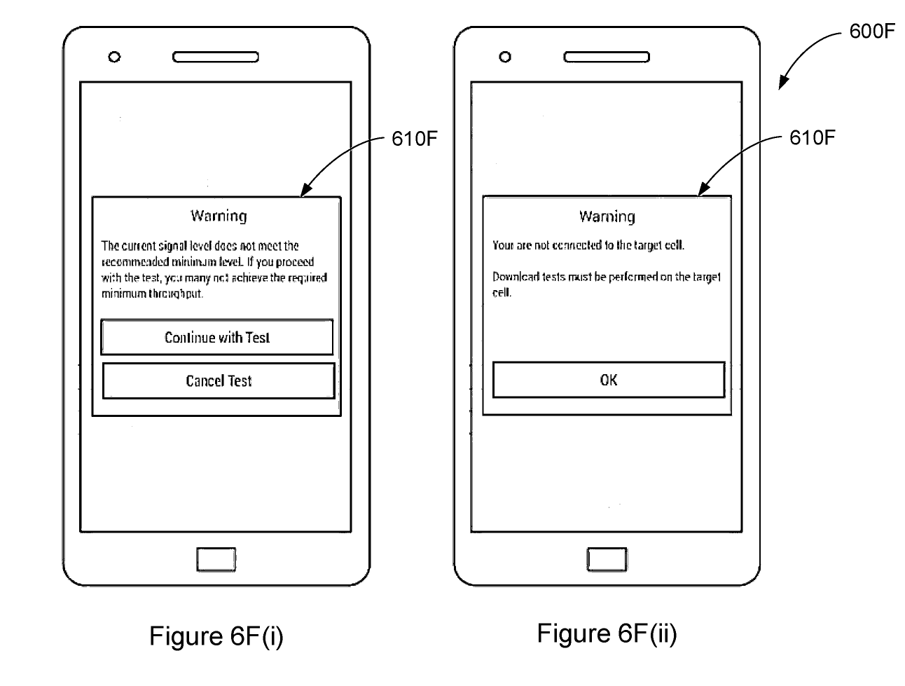

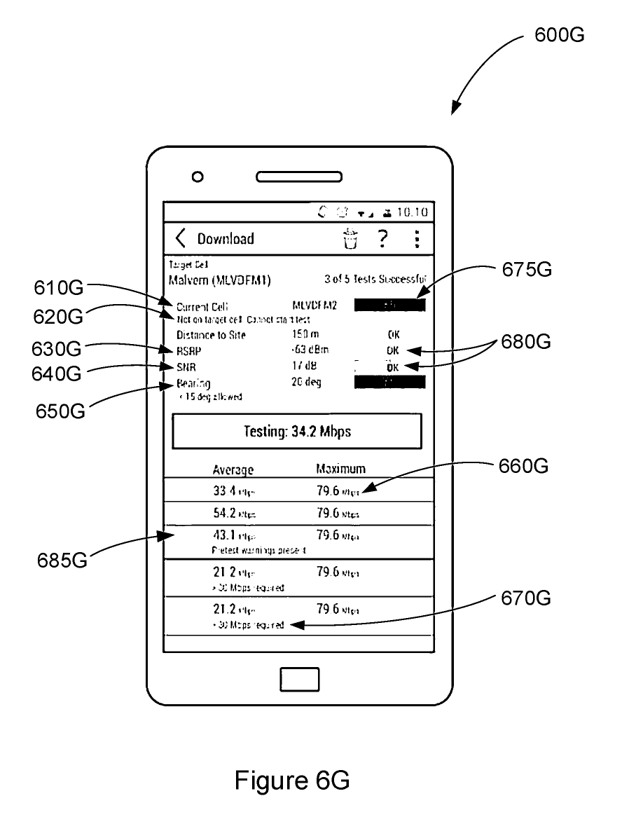

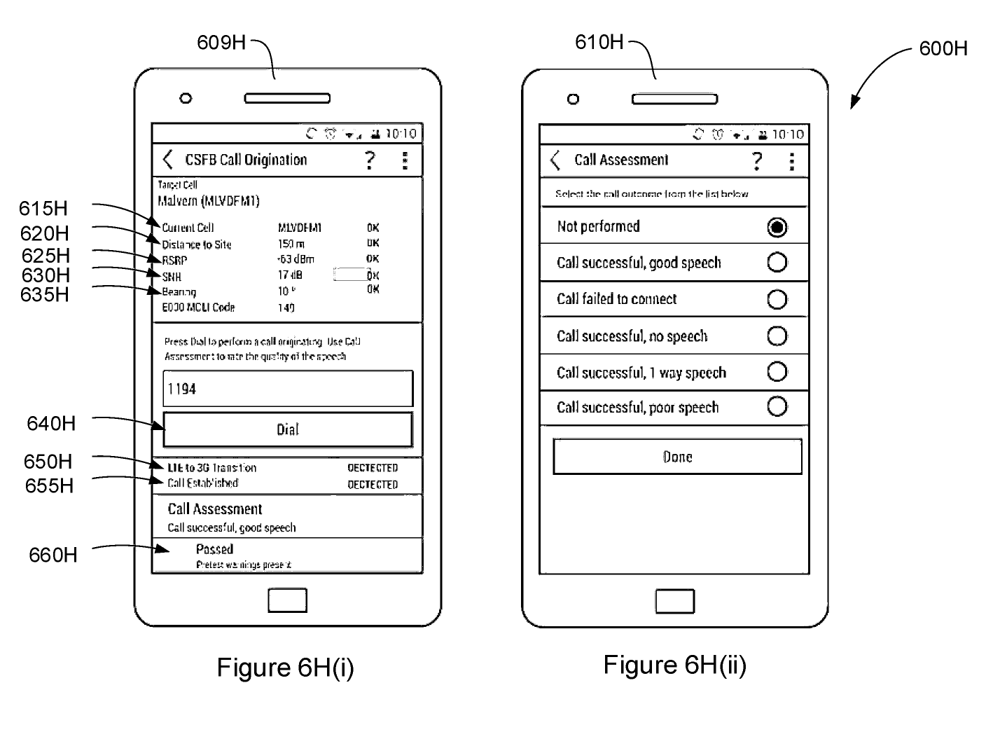

At step 445 the information about the connected cell is obtained including Cell Global Identity (CGI) and GPS information from the mobile device 110 and a distance is calculated between the site together with the bearing from the antenna associated with the cell. Control then moves to step 450 where the connected cell information is looked up via site configuration database 405. At step 445 the connected cell is compared against the pre-test criteria and in particular for the distance to cell, bearing to antenna, signal level and quality of signal. Control then moves to step 460 in which a map showing recommended test location overlay based on distance and bearing criteria is provided. This is shown in further detail with reference to FIG. 6A.

At step 465 the predicted coverage area may be overlayed on a map to indicate to the user visually the predicted coverage. This information is provided by site coverage and information plots 470.

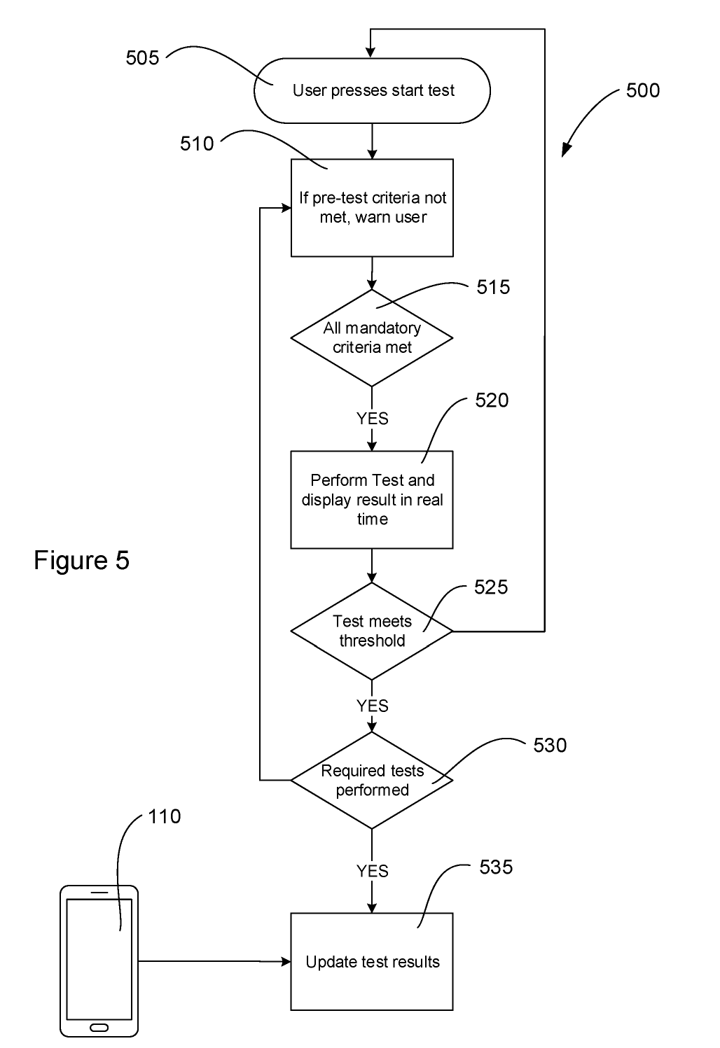

Control then moves to step 475 in which colour coding and display warnings are provided in real time in line with pre-test criteria and is shown to the user and in particular, if it is not met. In the situation where the pre-test criteria are not met, then control may return to step 445 until the pre-test criteria are met. Assuming pre-test criteria are met, control moves to the flow diagram as shown in FIG. 5.

FIG. 5 is flow diagram illustrating a method 500 for performance testing and post-test criteria for a cell. At step 505 the user associated with mobile device 110 initiates the test procedure of the cell and control moves to step 510 in which a warning is displayed to the user if pre-test criteria is not met. Otherwise control moves to step 515 in which it is determined whether or not all of the mandatory criteria are met. Any pre-test or other criteria can be configured to be mandatory or optional. Examples of mandatory criteria are: the connected cell, minimum signal level. In the event that the mandatory criteria are not, control may return to step 505. In the event that all mandatory criteria are met, control moves to step 520 in which a test is performed and the results are displayed in real time on the mobile device 110. At step 525, it is then determined whether or not the test meets a particular threshold for the post-test criteria. An example post-test threshold would be an acceptable average download throughput (e.g. 30 Mbps). In the event that the test does not meet the threshold, control returns to step 505 otherwise control moves to step 530 in which the test results are updated at step 535 in which the results may be tagged with test locations, user identification and the environment in which the test was performed. Also recorded may be mobile device 110 location (latitude and longitude for example) radio signal level and radio signal quality.

FIG. 6A is a screenshot 600a illustrating the environmental details based on pre-test criteria for a particular cell and includes detailed information such as the name of the connected cell or the type of technology the node identifier bandwidth distance to the site, strength and quality of signal and an IP address for example.

Also shown on the screen 600a are current user location (the user being associated with the mobile device) 605a, a predicted coverage 615a, a recommended test location 610a which is based on distance and bearing information and a connected cell indicator 620a. Also shown is detailed information 630a about the environment. Based on this information, the user associated with the mobile device may move to a better location to conduct the test.

FIG. 6B is a screenshot 600b which illustrates the site search functionality in which a user associated with a mobile device 110 may search for a site 610b or select the currently selected site 605b.

FIG. 6C is a screenshot 600c, the user associated with the mobile device 110 is presented with a list of technologies for which test can be performed and also illustrates the configuration of the site level tasks. Both the technology tests and the site tasks constitute a workflow and in particular the site task that is to be carried out 605C, the particular technology to be checked 610c and an option to then create the workflow 615c. In this screenshot, the user associated with mobile device 110 wishes to verify commissioning for the site, carry out voice and data performance checks on the LTE700 technology. WCDMA850 has been selected for a subset of performance tests (Quick Performance Check), while other technologies are not to be tested (Do Nothing).

FIG. 6D is a screenshot 600d illustrating the site workflow which was created in FIG. 6C and shows a high level summary of the status of the workflow. Each high level list entry represents a group of tests or tasks. The overall status for the test/task group is illustrated by an icon 610d and a total successful out of total tests required 620d. Additionally, the number of tests that resulted in a warning or a failure are highlighted 630d. The user selects a test or task to reveal the next level of detail.

FIG. 6E is a screenshot 600e showing the cell performance tests for the selected cell from illustration 600D. For completed tests, the individual results are shown inline 620e. A user selects a test to enter into the performance test module. Shown in 600E are the required tests of Download, Upload, Latency and Voice calling. The icons 610e indicate the passed, not completed (blank), passed with warning or failed status of the tests.

FIG. 6F is a screenshot 600F which illustrates examples of optional 610f and mandatory 620f pre-test warnings in the event that the current signal level from the cell doesn't meet the minimum requirements and the connected cell is incorrect. It queries with the user whether or not they wish to proceed with the test or not. They user may choose to proceed for the optional pre-test warning 610f in which case the test is conducted. For the mandatory pre-test warning 620f, the user must meet the required pre-test criteria and will be returned to the test.

FIG. 6G is a screenshot 600G illustrating testing of download capability and includes details such as the current cell 610g, distance to the site 620g, signal strength 630g and signal quality 640g, bearing 650g with regard to the location of the mobile device 110 to antenna 105, the speed of the download including averages, maximums and minimums 660g and whether or not each of these exceed a particular threshold 670g. The visual status of each of the pre-test criteria is shown 675g. The visual status is indicated by color (which may be red, orange and green for example) or depending on the criteria may also indicate a level in the form of a horizontal bar chart. A test post-criteria status is indicated by an icon 685g.

FIG. 6H is a screenshot illustrating circuit switched fall back (CSFB) originating call tests in which the user associated with mobile device 110 can, in addition to knowing the current cell 615H, the distance to the cell site 620h, the signal strength 625h and signal quality 630h and the bearing 635h, determine whether or not calls should be established. Once pre-test criteria have been met the user can initiate a call using a preconfigured phone number or a user entered phone number and by pressing 640H. In this scenario, once the call is complete, a call assessment 610h can then be provided as a post-test criteria which determines whether or not after hearing the call, the user associated with mobile device 110 successfully met the required criteria. For example, the call may not be performed, maybe successful with good speech, no speech, one way speech, poor speech and the like. Other variations of the call test being performed may include circuit switched calling (originating and terminating), emergency service calling, VoIP calling and the like. Pre-test criteria for these test variations may be similar to that of a CSFB test. Post-test criteria such as LTE to 3G transition detected 650h and phone detection that a call was established 655h are also automatically assessed. The overall test status along with a status string indicating the presence of pre-test warnings such as not being the correct distance to the cell is indicated in 660h.

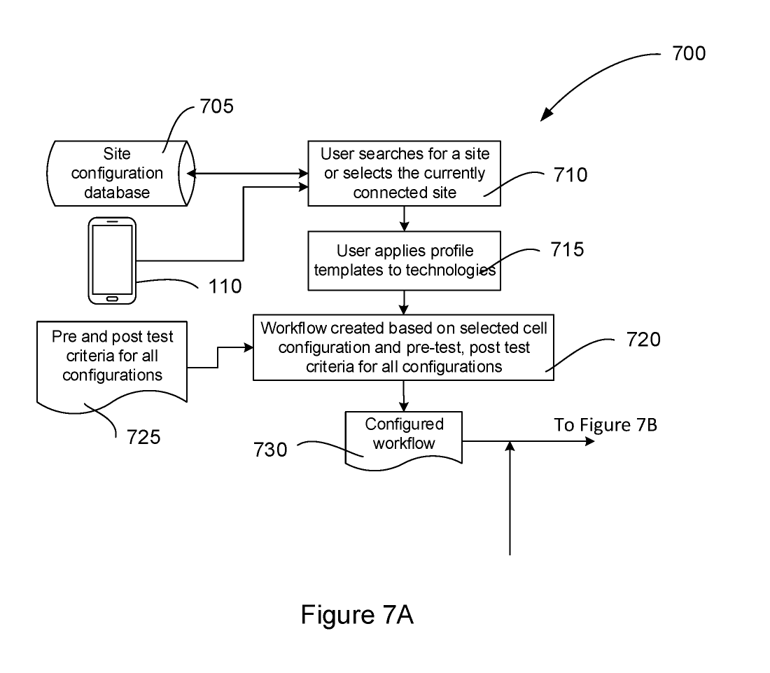

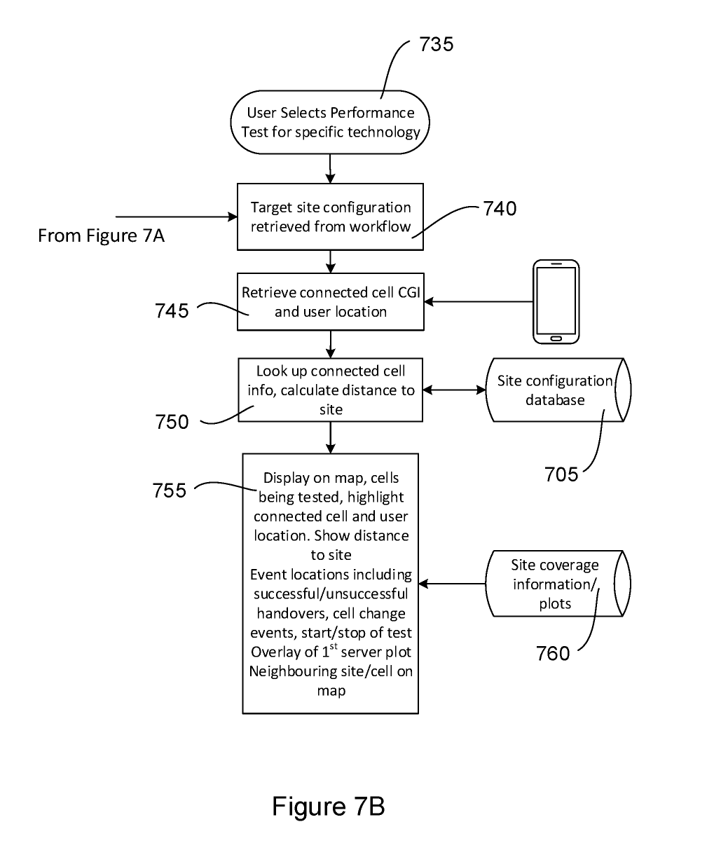

FIG. 7 is a flow diagram 700 illustrating creation of a workflow for performing a handover test together with generation and application of pre-test criteria. At step 710 the user searches for a site or selects the currently connected site from the handset 110 or via a site configuration database 705. Control moves to step 715 in which the user applies a profile template and control moves to step 720 in which a workflow is created based on selected cell configuration and pre-test and post-test criteria for a particular configuration. The pre-test and post-test criteria for the configuration may be provided from database 725. Control then moves to step 730 where a configured workflow is provided and at that point, handover test configuration may be provided including target site and technology, cells to be tested, throughput threshold, number of samples below threshold for a failed handover and number of samples to measure around a handover event.

At step 735, the user selects to test the performance for a specific technology which was determined at step 710. Control then moves to step 740 in which the target site configuration is retrieved from the workflow created at step 730. Control then moves to step 745 in which, via the mobile device 110 connected cell (CGI) latitude and longitude/user location is provided.

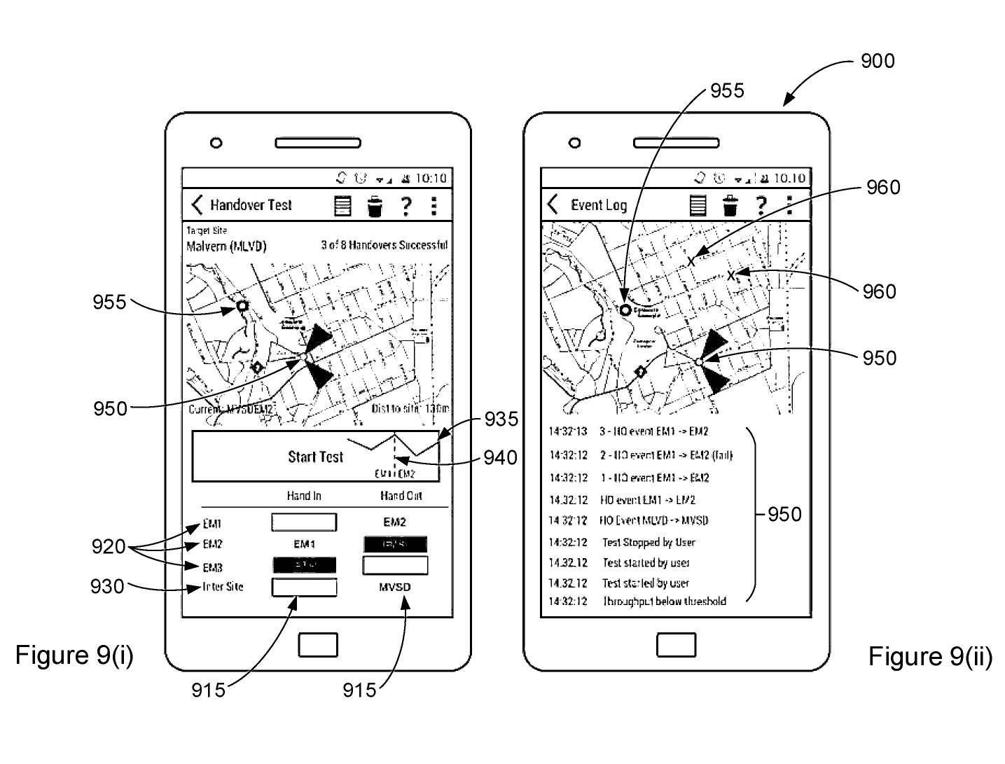

Control then moves to step 750 in which cell information is looked up and distance calculated to the site based on the site configuration database 705. Control then moves to step 755 in which a display on a map is generated, together with cells being tested and highlighting connected cell and user location on the mobile device 110. Also provided is distance to the site, event locations including successful and unsuccessful handovers, cell change events, start/stop test overlay and neighbouring sites/cells are provided on a map. This information is provided via site coverage information plots database 760. The data provided to the user associated with mobile device 110 at this point, will be shown further with reference to FIG. 9.

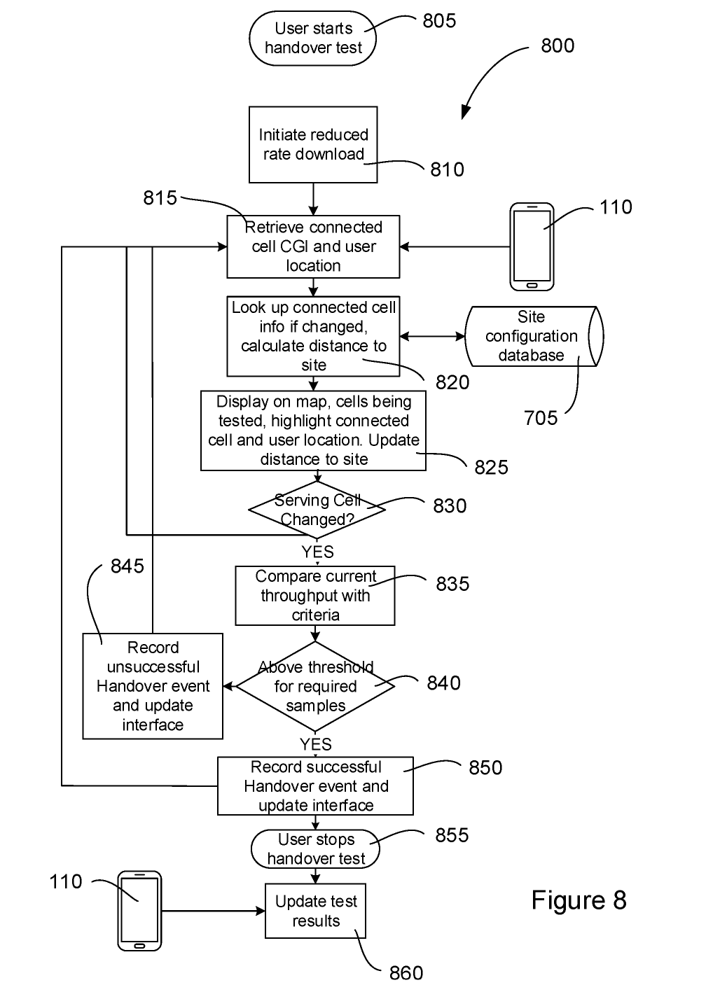

At this stage, at step 755, the user associated with mobile device 110 is in a position to carry out a handover test as shown in FIG. 8.

FIG. 8 is a method 800 for carrying out a handover test. At step 805, the user starts the handover test on the mobile device 110. Control then moves to step 810 in which a reduced rate download is initiated. A continuous download is required to measure the data service performance (throughput) during handover. To minimise the use of network resources for extended periods of time, the download rate is reduced (reduced rate download).

Control then moves to step 815 in which connected cell information and latitude and longitude and user location is determined via the mobile device 110. Control then moves to step 820 in which connected cell information is looked up via site configuration database 705 and is recalculated if the cell information has changed.

Control then moves to step 825 in which cells being tested are displayed on a map highlighted showing connected cell and user location, together with an updated distance to the site. Control then moves to step 830 where it is determined whether or not the serving cell has changed. If not, control returns to step 815. In the event the serving cell has changed and a handover has taken place, control moves to step 835 in which current throughput is compared with the handover event post-test criteria as configured in the workflow. Additionally, haptic and/or audible feedback may be provided to the user for event types such as the change of current cell (830), a failed handover (845). Events are identified with different tones and/or vibration patterns.

Control then moves to step 840 where it is determined whether or not the throughput is above the threshold required. In the event that is not, control moves to step 845 in which an unsuccessful handover event is recorded before returning to step 815. Otherwise control moves to step 850 in which the successful handover event is recorded. At step 855 the user may end the handover test if all required handover events have been successfully tested. At step 860 test results are provided and tagged with location, user identification and the environment in which the test was performed. Also provided is information via mobile device such as phone location including latitude and longitude for example, radio signal level and radio signal quality and the like.

FIG. 9 shows two screenshots 900 and 910 illustrating a handover test in which the user can determine whether or not handovers were successful. The user can toggle between a summary view 910 and a detailed event log 945. For the summary view 910, the cell and site events being tested are shown in a matrix of colour coded results 915. Typically, tests between cells 920 (handing out from one cell [EM1, EM2 and EM3] and into another) as well as tests between sites 930 (handing out from one site [MVSD] and into another) are required to be tested and represent post-test criteria to be met in order to successfully pass the test. The colours in the matrix 915 represent the following states: no handover detected (blank), handover detected successfully (green) and handover detected unsuccessfully (throughput degradation—red). The instantaneous throughput 935 and indication of cell change events 940 is shown. On both screenshots the location of the cell is shown 950 which also shows which cell is connected to. The location of the user 955 and the location of handover events 960 is also shown.

Any number of tests may be carried out with the system and method of the present invention including data performance testing and voice testing.

A data performance test (to test the performance of the cellular data network for a particular cell) may be provided, which operates in the same manner as FIG. 4 and FIG. 7 and may test download throughput, upload throughput, and latency for example. The performance test has several pre-test and post-test criteria. The pre-test criteria may be identical for download, upload and latency tests or may be configured to be different. The post-test criteria for download, upload and latency test will differ as each is measuring a different aspect of data performance.

A voice call test module may be provided to operate in the same manner as FIG. 4 and FIG. 7 and may have similar pre-test criteria to a data performance test. Post-test criteria for voice tests may include one or more of: user call connection assessment, user call speech quality assessment, LTE to 3G transition detected, phone detection that a call was established, automated speech quality assessment, data session was not disconnected or the like.

Additional post-test criteria for emergency service call tests may be to check with the emergency service operator that the correct location information has been passed from the mobile network to the call centre (referred to as the Mobile Location Information code MoLI in Australia).

1. A method for testing the performance of one or more cells in a wireless communication network using a mobile device, the method including:
determining cell information relating to the cell to be tested;
determining one or more pre-test criteria and one or more post-test criteria based on the cell information;
determining whether the one or more pre-test criteria are satisfied; such that if one or more of the pre-test criteria are satisfied, testing the performance of the cell via the mobile device by measuring data related to the one or more pre-test criteria, and determining whether the one or more post-test criteria are satisfied.

2. The method of claim 1, wherein the pre-test criteria and post-test criteria are automatically determined based on the cell information.

3. The method of claim 1, wherein the cell information includes one or more of: the type of cell, the technology type and generation, cell location, antenna type/configuration, occupied bandwidth, frequency of operation (band), site or cell backhaul capacity or type, cell voice usage, cell data usage, number of current connected users or configured peak cell throughput.

4. The method of claim 1, wherein the pre-test criteria includes one or more of a specific cell identity (CGI/BSSID), signal level threshold, a signal quality threshold, a distance threshold, cell voice usage, cell data usage and number of connected users or a bearing threshold.

5. The method of claim 1, wherein the pre-test criteria includes mandatory pre-test criteria and optional pre-test criteria.

6. The method of claim 1, wherein the post-test criteria includes mandatory post-test criteria and optional post-test criteria.

7. The method of claim 1, wherein the step of determining whether the one or more pre-test criteria are satisfied, includes:
determining the currently connected cell identifier and comparing against the required cell identifier;
determining the distance from the mobile device to the cell and comparing against the distance threshold;
determining the bearing of the mobile device to the cell and comparing against the bearing threshold;
determining the signal level between the mobile device and the cell and comparing against the signal level threshold; and
determining the signal quality between the mobile device and the cell and comparing against the signal quality threshold.

8. The method of claim 7, further including the step of displaying on the mobile device, one or more of:
the determined currently connected cell identifier;
the determined distance from the mobile device to the cell;
the determined bearing of the mobile device to the cell;
the determined signal level between the mobile device and the cell;
the determined signal quality between the mobile device and the cell.

9. The method of claim 8 wherein a recommendation is made for a test location based on one or more of the determined distance, bearing, signal level or signal quality between the mobile device and the cell.

10. The method of claim 1, wherein the post-test criteria includes one or more of a minimum performance threshold (download throughput, upload throughput and network latency, web page load time threshold, packet delay variation threshold, packet loss threshold), a manually assessed or automated voice quality score or a user assessment of the performance, or a required number of successful tests threshold.

11. The method of claim 1, wherein determining whether the one or more post-test criteria are satisfied includes the steps of:
determining one or more of the download throughput, upload throughput, network latency, web page load time threshold, packet delay variation threshold, packet loss threshold, a manually assessed or automated voice quality score or a user assessment of the performance between the mobile device and the cell and comparing against the performance threshold.

12. The method of claim 1, further including the step of determining whether the number of tests carried out exceeds the required number of tests threshold.

13. The method of claim 1, wherein the pre-test criteria includes one or more of the currently connected radio technology, distance to site, signal level and signal quality.

14. The method of claim 1, wherein the step of determining, whether the one or more pre-test criteria are satisfied, includes:
determining the cell identifier of the cell that the mobile device is connected to and comparing against the required cell identifier;
determining the distance from the mobile device to the cell and comparing against the distance threshold;
determining the signal level between the mobile device and the cell and comparing against the signal level threshold; and
determining the signal quality between the mobile device and the cell and comparing against the signal quality threshold.

15. The method of claim 1, further including the step of displaying on the mobile device, one or more of: the cells being tested, the current connected cell and location of the mobile device, distance to the current cell, locations of successful and unsuccessful handovers, cell change events, a matrix of required handover events and their detected handover status, a list of network and test events, list of cells to be tested, instantaneous data performance, overlay of handover events, wireless network coverage map and the start and stop of the test.

16. The method of claim 1, wherein the post-test criteria includes one or more throughput thresholds, sample thresholds for failed handover events, the number of samples to measure around a handover event and the number of successful handover events to be measured.

17. The method of claim 1, wherein determining whether the one or more post-test criteria are satisfied includes the steps of:
determining the current connected cell and current mobile device location;
determining whether the cell has changed and if the cell has changed, comparing the throughput of the cell against the post-test criteria.

18. The method of claim 1 wherein upon starting the handover test a data performance test is initiated and wherein the performance test is one or more of: a download test, an upload test, a latency test, a voice call assessment (automatic or manual), or a network connectivity state test.

19. The method of claim 1, wherein a throughput test is used to measure the success of the handover event, a reduced rate download or upload test is initiated.

20. The method of claim 1, wherein a handover test event may occur and be of type: successful handover, unsuccessful handover, cell change event, loss of connectivity event, establishment of connectivity event, may result in the user being altered audibly or via vibration of the phone.

21. A method for testing the performance of one or more cells in a wireless communication network using a mobile device, the method including:
determining cell information relating to the cell to be tested;
determining one or more pre-test criteria based on the cell information;
determining whether the one or more pre-test criteria are satisfied; such that if one or more of the pre-test criteria are satisfied, testing the performance of the cell via the mobile device by measuring data related to the one or more pre-test criteria.

22. A method for testing the performance of one or more cells in a wireless communication network using a mobile device, the method including:
determining cell information relating to the cell to be tested;
determining one or more post-test criteria based on the cell information; testing the performance of the cell via the mobile device by measuring data related to the one or more post-test criteria, and determining whether the one or more post-test criteria are satisfied.

23. A system for testing the performance of one or more cells in a wireless communication network using a mobile device, the system including:
a server configured to determining cell information relating to the cell to be tested;
the server determining one or more pre-test criteria and one or more post-test criteria based on the cell information;
a mobile device, in communication with the server which determines whether the one or more pre-test criteria are satisfied; such that if one or more of the pre-test criteria are satisfied, performance of the cell is tested via the mobile device by measuring data related to the one or more pre-test criteria, and determining whether the one or more post-test criteria are satisfied.
